(19) United States
(12) Patent Application Publication
(10) Pub. No.: US 2007/0193951 A1
(43) Pub. Date: Aug. 23, 2007

(54) Method of processing liquid waste, emission, dust, and ash to solid substances

(75) Inventor: Caius Emeka Egbufoama, Bladensburg, MD (US)

Correspondence Address: CAIUS EMEKA EGBUFOAMA, APT 706, 5802 ANNAPOLIS RD, BLADENSBURG, MD, 20710, US

(73) Assignee: CAIUS EMEKA EGBUFOAMA

(21) Appl. No.: 11/215,750

(22) Filed: Aug. 31, 2005

(51) Int. Cl. C02F 9/00

(52) U.S. Cl. 210/631

(57) ABSTRACT

A method of processing liquid waste, whereas sludge liquid is separated from sludge solid, the sludge solid is pasteurized, and pumped into the formation Unit The heat gases (emission, air pressure, ash, dust, and etcetera) are used to move sludge solid to more than one direction creating ocean waves look alike and the liquid substance in sludge solid is steamed out of the unit to designated location and the dried substance becomes an energy fuel product equivalent to coal.

### FIELD OF INVENTION

The present invention relates to a process for condensing municipal and industrial waste to solid substances and some of the solid substances are converted to renewable energy producing products. Currently I have full knowledge about using municipal and industrial waste such as manure, milk, raw sewer, and etcetera to produce methane gas, carbon dioxide, hydrogen sulfide, and ammonia I was drawn into this invention by my interest in clean environment and alternative energy source. In my lab research to invent a new technology process that is environmental friendly and self sustaining, I discovered ways to condense municipal and industrial waste to solid substances and I focused my interest on liquid waste such as raw sewer, manure, milk, etcetera; emission, dust, and ashes. Because of my background in electrical engineering I was lead to discover energy potential in raw sewer, and manure when they are converted to solid substances or substance and each substance has high BTU equivalent to coal.

The main advantages of the technology process are that it will eliminate the processing of waste water, the discharge of sludge liquid into the water ways and sludge solid at farms; it also will reduce plant operational cost. The most important is that provides clean environment, two forms of alternative energy products, and it is self sustain.

### SUMMARY

The technology process eliminates the processing of municipal and industrial waste at waste treatment plants. It converts waste such as:—raw sewer, raw manure, ash emission, dust, and etcetera to energy producing products. The process is operated by separating sludge solid from sludge liquid and using heat gases form the Combustion Unit to drive liquid in sludge solid in the units out, whereas the sludge solid and the stream produced in the units trap the emission, ash, and dust from entering the environment. The organics leaves the units as steam is injects into the Recycle Unit for cleansing. The low level steam produced during the process freezes in the cooler, the sludge liquid is condensed to solid substance by adding foreign products and the solid substance is processed as low grade energy product and the sludge solid is processed as high grade energy product.

### PROCEDURE

Combustion: The Combustion Unit is used to provide heat for all the units. The first initial heat in the Combustion Unit is generated by the use of dried corn, natural gas, wood, or coal to dry sludge solid and the dried sludge solid becomes the source of energy for processing of sludge solid to energy products and self sustaining. The goal is to keep the temperature in the Combustion Unit steady at 3,000 Deg Fahrenheit and above and not lower than 2,000 Deg Fahrenheit.

Second, liquid waste is deposited into a Holding Unit allowing sludge solid (bio-solid) and etcetera to settle at the bottom of the unit and sludge liquid settling at the top. Some of the sludge liquid is gradually pumped out to Recycle Unit for other use. The sludge solid is moved to a Pasteurizer Unit where it is pasteurized at 80 to 400 Deg Fahrenheit forcing the breakdown of complex organic matter into simple organic compounds. Acid forming bacteria, microorganisms' further breakdown the compound into methane, carbon dioxide, hydrogen sulfide, and etcetera. Injecting low air pressure into Pasteurizer Units forces methane gas, carbon dioxide, and etcetera to exit into the Combustion Unit to provide additional heat for Combustion.

Third, the pasteurized sludge solid is pumped into Formation Unit Formation is the process of using heat gases (air pressure, emission, dust, heat, and etcetera) to drive out liquid substance present in the sludge solid into steam before the sludge solid is released into the Dryer Unit.

Method of Formation: Air pressure from the pressure tank is injected into the Combustion Unit The air pressure carries gases circulating in the Combustion Unit into the Formation Unit and the Dryer Unit through each unit's individual vacuum lines. At the same time gases circulating in the Dry Unit will loop into the Formation Unit this process increases the gas level in the Formation Unit therefore forcing sludge solid to form ocean wave look alike, moving more than one directions and twist around. As the sludge solid twist, the heat gases in the unit will force the liquid substances in sludge solid to steam out of the Formation Unit The pressure of the steam leaving the Formation Unit will push the pressure holders at the top of the unit forward and the steam will escape through the vacuum lines and inject into the Recycle Unit for cleansing The steam produced in the Recycle Unit is injected into the Cooler Unit and freezes at −150 Degrees.

Depending on the size of Formation Unit and the temperature level in the units, the average recommended time for formation is twenty-five (25) minutes to obtain 35% (percent) dry before sludge solid is released from the Formation Unit to the Dryer Unit; new pasteurized sludge solid is deposited into the Formation Unit for another processing. Method of Drying: Sludge solid is deposited from Formation Unit to Dryer Unit Oxygen is injected from Air Pressure Unit into Combustion Unit. The oxygen level in the units is increased because of new formation in the Formation Unit. The gas present in Dryer Unit will raise forcing sludge solid to form ocean wave, moving more than one direction in the unit. As the sludge solid twist, the heat gases in the unit will force the remaining liquid contained in sludge solid to evaporate into the Formation Unit At the end of every twenty minutes (20), the sludge solid at 50% (percent) dry is released to Energy Unit where it is dried at low temperature to obtain 60% to 75% (percent) dry. At 60% (percent) dry and above, sludge solid has been formatted to energy (fuel) product The temperature in Energy Unit is kept constantly at 70 Degrees to 100 Degrees Fahrenheit to slowly obtain 75% dry completion and at the same time completely preserve fats present in sludge solid The process is repeated continuously.

Method of Converting Sludge Liquid to a Solid Substance:

The process involves depositing heat conducts and liquid absorbents such as ash, corn, millet, rye, white, oat, wheat, and Soya beans independently or combined into the Recycle Unit. By doing so, the sludge liquid in the unit is thicken and processed as sludge solid. The organics leaving the Recycle Unit as low pressure steam is injected into the Cleanser Unit where it is filtered and injected into the Cooler Unit freezes at −150 Degrees.

What I claim:

1. I am claiming the method of processing liquid waste, whereas sludge liquid is separated from sludge solid. The sludge solid is pasteurized and pumped into the formation Unit. The heat gases (heat, emission, air pressure, ash, dust, and etcetera) force sludge solid to move more than one direction creating ocean waves look alike and the liquid substance in sludge solid is steamed out of the unit to designated location and the dried substance becomes an energy fuel product equivalent to coal.

2. I am claiming the method of processing sludge liquid to solid sludge or solid substance; whereas foreign products such as dry corn, millet, rye, Soya beans, beans, wheat, oats, barley, and ash crushed or uncrushed are used combined or independently as liquid absorbent to thicken sludge liquid before it is processed to low grade energy fuel product.
